(19) United States
(12) Patent Application Publication
(10) Pub. No.: US 2012/0209639 A1
(43) Pub. Date: Aug. 16, 2012

(54) FUNCTION SPACE RESERVATION SYSTEM

(75) Inventors: Len Chan, North York (CA); Massood Delairi, Scarborough (CA); David McRitchie, Toronto (CA); Wayne Murphy, Toronto (CA); Jujhar Singh, Palo Alto, CA (US); Colin K. Toal, Brampton (CA); Derek Wagland, Toronto (CA); Bowen Wang, Fremont, CA (US); Hideki Yamada, Newmarket (CA)

(73) Assignee: Oracle International Corporation, Redwood Shores, CA (US)

(21) Appl. No.: 13/455,162

(22) Filed: Apr. 25, 2012

Related U.S. Application Data
(63) Continuation of application No. 10/602,245, filed on Jun. 23, 2003.

(51) Int. Cl. G06Q 10/02

(52) U.S. Cl. 705/5

(57) ABSTRACT

Systems and methods to provide an availability and price determination, in response to a request for function space, to a user in real-time. For one embodiment, a request for a function space is received at a digital processing system that contains availability information and a set of pricing rules for one or more function spaces. The request includes a plurality of criteria. An availability of the requested function space is determined based upon the availability information and one or more of the criterion. A price for the requested function space is determined based upon the set of pricing rules and one or more of the criterion.

### RELATED APPLICATIONS

The present application is a continuation of and claims priority from co-pending U.S. application Ser. No. 10/602,245, entitled, “Function space reservation system”, filed on 23 Jun. 2003, and is incorporated in its entirety herewith.

### FIELD

Embodiments of the invention relate generally to the field reservation methods and more specifically to methods for establishing availability and determining price quotes for guest rooms and function space.

### BACKGROUND

Conventional methods for establishing availability and determining price quotes for guest rooms and function space in, for example, the hospitality (hotel) industry, are inefficient, time consuming and often produce erroneous results. Typically, when a consumer wishes to book accommodations for an event (e.g., wedding, convention, etc.), the customer provides a request that includes desired event criteria to a central location (e.g., a national sales office). The criteria typically include a date and time for the event, the expected attendance, types and quantities of food and beverages and function space (e.g., ballrooms, banquet halls, conference rooms, etc.). The criteria may also specify other requirements, including setup styles, area and the desired amenities and guest room availability.

The central reservation office forwards the customer's request to one or more individual facilities capable of meeting the desired event criteria. A sales manager at each facility then determines if the requested function space and guest rooms are available for the requested date or dates. If the requested function space is available, the sales manager determines a price quote for the function space. This process is repeated at each of the properties meeting the desired event criteria. Due to the complex considerations involved in determining availability and a price quote, this process often takes hours to complete.

The availability determination and price quote are returned to the central location, which in turn provides the price quote to the customer. During the delay from the time of the initial inquiry to presentation of a definitive response, the customer likely will have made inquiries with competitors, thereby decreasing the probability of a final sale.

Typical function space reservation and management schemes suffer from additional drawbacks including, for example, the manner in which reservations are made and the generation of erroneous price quotes due to lack of consideration of complex market factors.

### Specific-Space Reservation

When a reservation is made for a function space, the reservation applies to a specific function space. That is, at the time of reservation, the facility sales manager allocates an actual, physical function space to fulfill the function space requirements of the reservation. This ensures that function space is available to meet the reservation commitment. Such a reservation policy can lead to inefficient use of available function space and, consequently, lost revenue.

FIG. 1 provides a simplistic illustration of a drawback of specific-space reservations in accordance with the prior art. Graphical representation 100, shown in FIG. 1, includes a representation of five, indivisible, physical spaces, namely rooms Rm. A-Rm. E, for a particular day. Each room can be combined with physically adjoining rooms to provide a larger function space. As shown, a specific-space reservation 101 has been taken for Rm. B and Rm. C, combined. Another specific-space reservation 102 has been taken for Rm. E. With specific-space reservations 101 and 102, a requested reservation for two adjoining rooms for the same day will have to be denied as unavailable. That is, because existing specific-space has been allocated to fulfill the requirements of reservations 101 and 102, two adjoining rooms are not available for that particular day, despite the amount of unreserved function space. If Rm. A and Rm. B had been allocated to specific-space reservation 101 instead of Rm. B and Rm. C, then Rm. C and Rm. D would have been available to fulfill the requirements of the proposed reservation. Alternatively, If Rm. A had been allocated to specific-space reservation 102 instead of Rm. E, then the Rm. D and Rm. E would have been available to fulfill the requirements of the proposed reservation. There could be any number of reasons why specific-space reservations 101 and 102 were mapped to specific space in this manner. For example, a reservation for Rm. A may have been in-place at the time specific-space reservation 102 was made. For whatever reason, the specific-space reservation leads to inefficient use of function space and lost revenue.

### Erroneous Price Quotes

The number and complexity of considerations on which a price quote is based is so great that pertinent information is often not considered in determining a price quote. That is, even when given the typical time frame of several hours or even days, a sales manager may neglect to consider information crucial to the determination of the optimal price quote. For example, one of the considerations for a price quote is market conditions. Therefore, if Sunday afternoons in January are not a particularly desired time for an event, every hotel in a given geographical area may substantially lower their prices for function space. If the sales manager of a particular hotel does not consider this market condition, an uncompetitive price quote results. Failing to provide a competitive price may lead to lost sales. On the other hand, if the Superbowl is scheduled to be played in the particular city on that Sunday, or a large convention is scheduled, then it may be possible to increase the price for function space. Failing to adequately exploit such circumstances may lead to lost revenue.

Not only may a sales manager fail to adequately consider the pertinent information due to the amount and complexity, but also, due to continually changing circumstances, a sales manger may not even be aware of all of the pertinent factors that should be considered. That is, during the delay in providing a price quote, conditions may change that are not reflected in the price quote. Erroneous price quotes are bound to occur with resulting lost sales and revenue.

### SUMMARY

Embodiments of the invention provide systems and methods to provide an availability and price determination in response to a request for function space. For one embodiment, a request for a function space is received at a digital processing system that contains availability information and a set of pricing rules for one or more function spaces. The request includes a plurality of criteria. An availability of the requested function space is determined based upon the availability information and one or more of the criterion. A price for the requested function space is determined based upon the set of pricing rules and one or more of the criterion.

Other features and advantages of embodiments of the present invention will be apparent from the accompanying drawings and from the detailed description that follow below.

### BRIEF DESCRIPTION OF THE DRAWINGS

The invention may be best understood by referring to the following description and accompanying drawings that are used to illustrate embodiments of the invention. In the drawings:

FIG. 1 provides a simplistic illustration of a drawback of specific-space reservations in accordance with the prior art;

FIG. 1A illustrates the structure of space products in accordance with one embodiment of the invention;

FIG. 2 illustrates a process by which a reservation for function space is requested and established in accordance with one embodiment of the invention;

FIG. 3 illustrates a system for receiving function space reservation requests and establishing a corresponding function space reservation in accordance with one embodiment of the invention;

FIG. 4 illustrates a correspondence between specific physical space and category space in accordance with one embodiment of the invention; and

FIG. 5 illustrates a process by which a space product is allocated to fulfill the requirements of a reservation request in accordance with one embodiment of the invention.

### DETAILED DESCRIPTION

### Overview

Embodiments of the present invention provide the ability to centrally maintain availability and pricing information for space product (e.g., a function space) at a plurality of individual sites and, in response to a user request, provide the information to the user in real-time (i.e., approximately as fast as the user can input the request). For one embodiment, availability and pricing information for a space product at each hotel of a hotel chain is maintained at, and accessed, from a central location. One embodiment of the invention optimizes space utilization by maintaining and searching availability and pricing information for a space product at multiple properties and suggesting alternatives at various properties. Such an embodiment employs complex algorithms, availability and pricing; thereby increasing reservations and revenue for a space product. For one embodiment, the revenue yield of the space product is increased by accepting reservations based upon the category of the space product as opposed to a specific space product. Such an embodiment allows more efficient use of available space and also increases revenue by allowing more efficient overbooking of the space in the event the requested space is not currently available.

In the following description, numerous specific details are set forth. However, it is understood that embodiments of the invention may be practiced without these specific details. In other instances well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

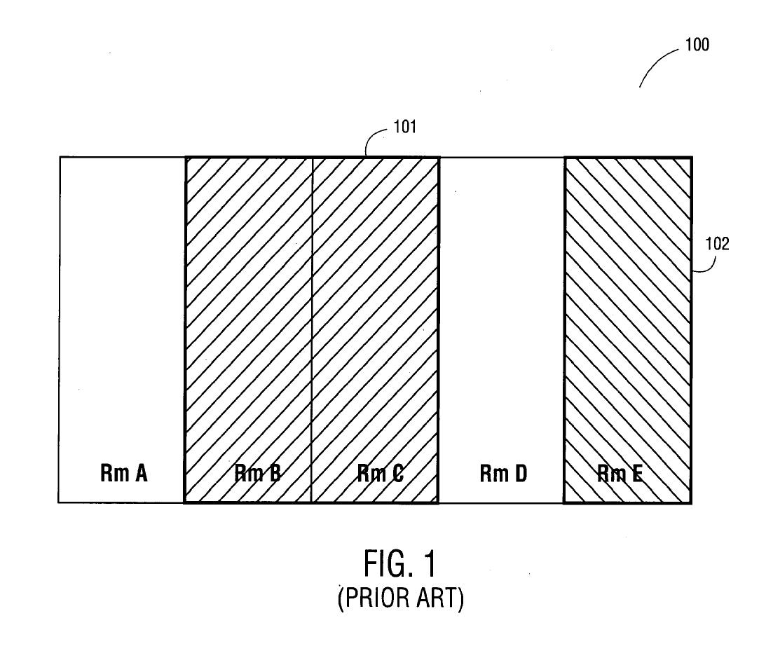

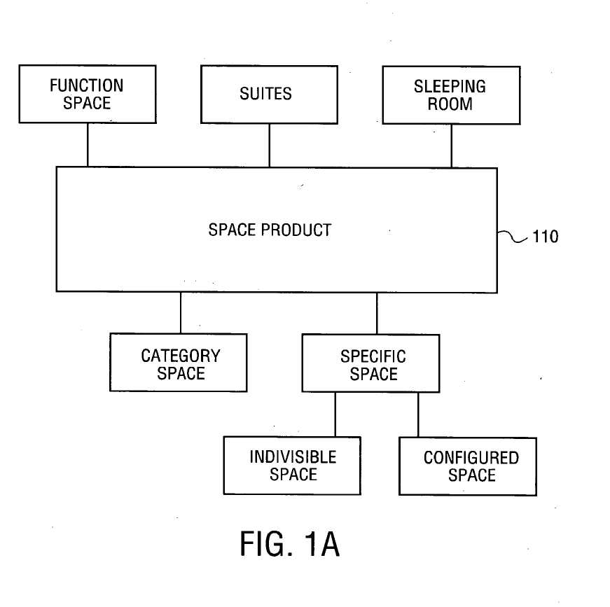

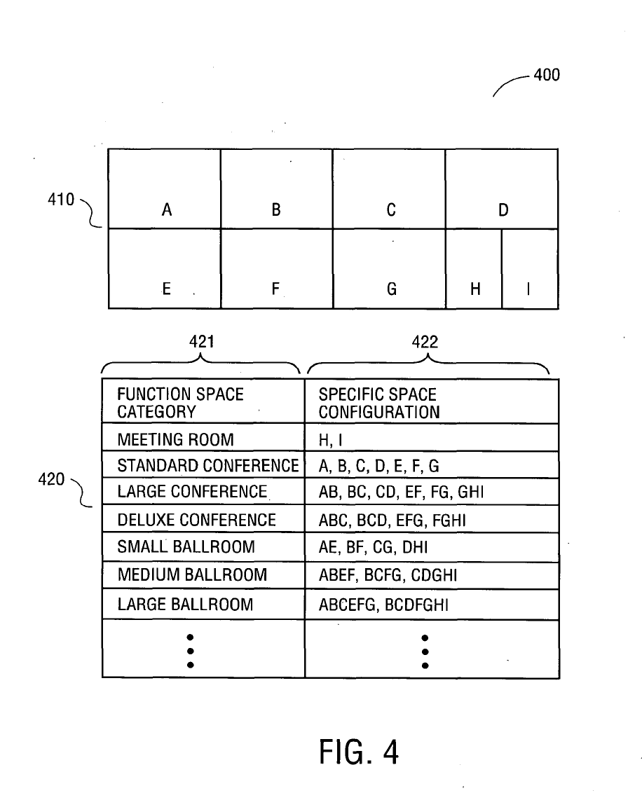

In accordance with one embodiment, the space products are structured so as to facilitate optimal and accurate availability determinations and pricing. FIG. 1A illustrates the structure of space products in accordance with one embodiment of the invention. As shown in FIG. 1A, space product 110, which is defined as any area that may be let, may consist of function space 111, sleeping rooms 112, or suites 113, which may be used for either sleeping or functions. The space product is designated based upon what the space is used for. Space product 110 may also be structured as category space 114 or specific space 115 to optimize space utilization. The specific space 115 may be indivisible space 116 (space that cannot be subdivided) or configured space 117. Configured space 117, which is a combination of indivisible spaces, and category space 114 can be used to optimize use of available space as described below in reference to FIG. 4.

### Process

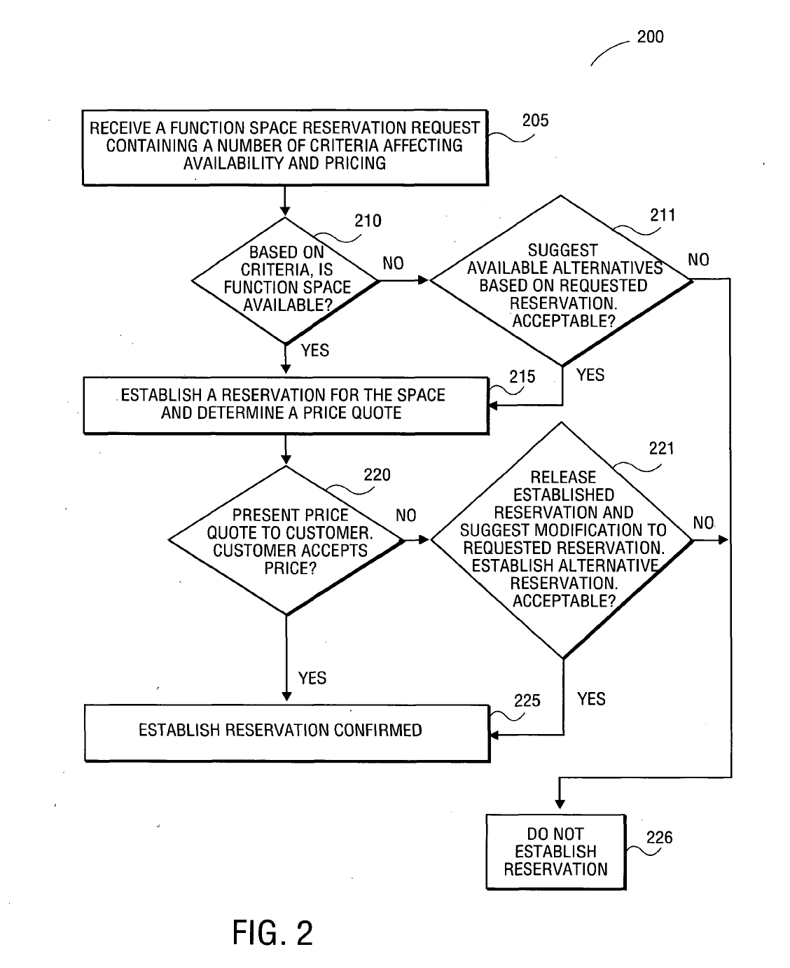

FIG. 2 illustrates a process by which a reservation for a space product (e.g., function space) is requested and established in accordance with one embodiment of the invention. Process 200, shown in FIG. 2, begins with operation 205 in which a reservation request for function space is received from a customer at a central reservation data processing system (“DPS”) which may contain availability and pricing information for various function space entities ranging from an individual property to an entire hotel chain, covering thousands of individual properties worldwide and several within particular geographical locations. As described above, the reservation request typically includes a number of criteria.

At operation 210 the criteria of the reservation request are used to determine the best fit for a space product (e.g., a function space). The criteria are compared to the availability information contained in the central reservation DPS. The search is narrowed based upon specific criteria. For example, if the reservation request is specific to a geographical area (e.g., a particular city), or quality-specific (e.g., five-star hotel), then the central reservation DPS compares the reservation request criteria to the several properties that meet the specified criteria. Additionally, if the reservation criteria include a specific setup style and time, then the setup time and teardown time associated with the specified setup style and attendance are used to determine the total time for which the space should be allocated.

If, at operation 210, it is determined that function space is not available to meet the reservation request, then, at operation 211, alternatives to the requested reservation may be provided to the customer. That is, based on what is available, the closest approximation to the reservation request can be quickly provided. Because all of the availability information is contained in the central reservation DPS, embodiments of the invention not only allow a function space vendor to quickly establish availability based on a reservation request, but also allow quick improvisation to provide a customer with available alternatives. If alternatives are not acceptable to the customer the reservation may not established at operation 226.

If, at operation 210, it is determined that function space is available to meet the reservation request, then, at operation 215, a reservation for the space is established and a price quote is obtained. To obtain a price quote, the central reservation DPS applies some or all of the general and specific pricing rules. For example, a hotel chain may have a general pricing rule that provides a pricing discount for function space based upon the attendance of the event or the total area of the function space reserved. Each individual property may implement property-specific pricing rules as well.

At operation 220 the price quote is presented to the customer. If the price quote presented is unacceptable to the customer, then at operation 221, the reservation is released and alternatives to the requested reservation may be provided to the customer. That is, modifications to the reservation request that affect the price in a variety of ways can quickly be provided to the customer. Again, because all of the availability and pricing information is contained in the central reservation DPS, embodiments of the invention not only allow a function space vendor to quickly provide a price quote based on a reservation request, but also allow quick improvisation to provide a customer with available alternatives at various prices. If an alternative is acceptable, a reservation based on the alternative is established and a price quote is determined (i.e., the process returns to operation 215. If alternatives are not acceptable to the customer the reservation is not established at operation 226.

If the price quote presented at operation 220 is acceptable to the customer, then the established reservation is confirmed at operation 225. This means that the requested function space, together with the other reservation request criteria will be available at the requested date and time.

As described, embodiments of the invention ensure that a customer is quickly provided with a determination of availability and a price quote. This increases the likelihood that a reservation will be established. Further, embodiments of the invention help to ensure that all of the numerous and complex pricing rules will be employed to produce an accurate price quote. This helps to ensure that the price quote provided is competitive and exploits market conditions to increase revenue. For alternative embodiments, a price quote may be determined even where the requested function space is unavailable to establish an optioned reservation. The function space is maintained as unreserved and if it subsequently becomes available, a reservation is established.

### System

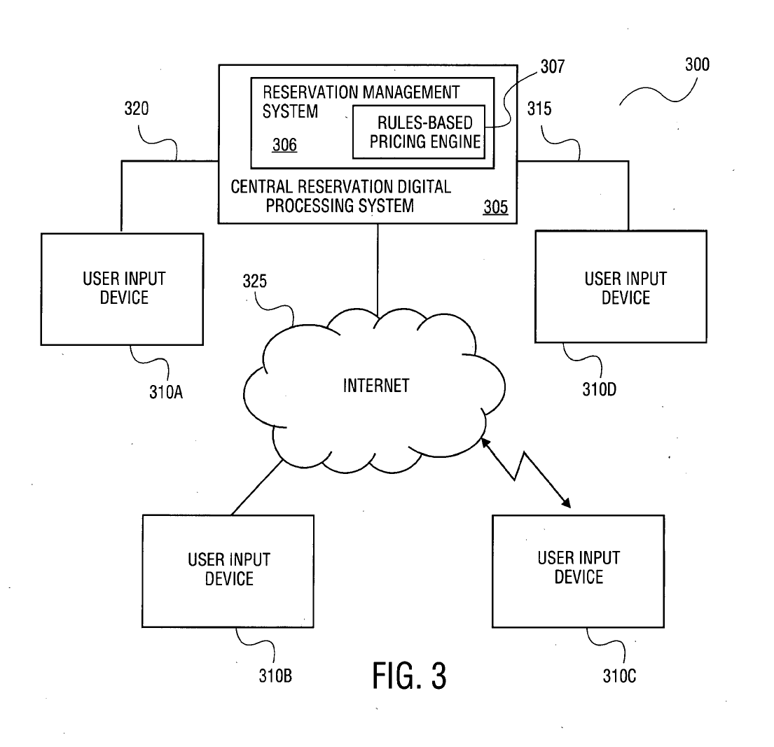

FIG. 3 illustrates a system for receiving function space reservation requests and establishing a corresponding function space reservation in accordance with one embodiment of the invention. Network 300, shown in FIG. 3, includes a central reservation DPS 305 having a reservation management system 306 stored thereon. The reservation management system 306 contains availability and pricing logic 307, which, for one embodiment, may be a rules-based pricing engine. A plurality of local or remote user input devices 310a-310d are coupled to the central reservation DPS. User input devices 310a-310d may be, for example, the telephones or DPSs of potential customers, or the telephones or DPSs of sales managers at individual properties serviced by the reservation management system 306.

The central reservation DPS 305 may be coupled to user input devices over short distances as part of a local area network (“LAN”) 315. Additionally or alternatively, the central reservation DPS 305 may be coupled to the user input devices over long distances via telephone lines or satellite links as part of a wide area network 320 (“WAN”) or over the Internet 325. The Internet 325 is a network of networks through which information is exchanged via the use of protocols (e.g., TCP, IP) as known in the art.

For purposes of illustrating an embodiment of the invention, central reservation DPS 305 may be a central processing system and database for a multi-location hotel chain with customers and local sales managers accessing the reservation management system 306 to obtain availability and pricing information for function space at one or more individual properties. For example, a customer could enter the specifics of a function space reservation request via a hotel chain website and receive, in fairly short order, a definitive response in regards to availability and pricing for the requested function space. This means the customer no longer has to wait hours or days for a response and is therefore less likely to inquire of competitors. Additionally, or alternatively, a sales manager at an individual hotel property could enter the specifics of a function space reservation request and receive a price quote based upon consideration of a number of complex factors aimed at increasing revenue. This decreases the likelihood that a sales manager will fail to consider one or more revenue-increasing pricing factors.

### Category Space Allocation

As discussed above, when a reservation has been established, allocating specific space to fulfill the function space requirements of the reservation often results in inefficient function space use and lost reservations and revenue. An embodiment of the invention reduces such inefficiencies by delaying the allocation of specific space to fulfill reservation function space requirements. In accordance with one embodiment of the invention, at the time the reservation is established, category space is allocated to fulfill the functions space requirements of the reservation. Each category consists of groups of specific function space with similar capacity (and/or other attributes).

FIG. 4 illustrates a correspondence between specific physical space and category space in accordance with one embodiment of the invention. Category space mapping 400, shown in FIG. 4, depicts a function space map 410 having a number of indivisible function spaces that may be of a variety of sizes. For example, function spaces A-G are one size (e.g., standard conference room size), while function spaces H and I are another size (e.g., meeting room size). Function spaces that are adjoining may be combined to create a larger function space of a different category. Function space category table 420 includes a number of function space category entries, each having a corresponding specific space configuration entry indicating the corresponding indivisible function spaces that may be combined to create a function space of a given category. For example, adjoining function spaces A and B of category “standard conference room” may be combined to create function space AB of category “large conference room.” Function space category table 420 includes several of the possible categories of function space and corresponding configurations of indivisible function space to realize the various function space categories.

Establishing reservations based upon category space, as opposed to specific space, adds flexibility to the reservation management system. For example, referring to FIG. 4, suppose two reservations are established, the first for two separate meeting rooms, and the second for a small ballroom. The prior art specific space reservation would allocate, for example, function spaces H and I to the first reservation and function spaces C and G to the second reservation, with other allocations being possible. Therefore, if a third reservation for a large ballroom was requested, it would have to be denied based on unavailability, regardless of subsequent cancellations. However, by establishing the reservation based upon category space in accordance with an embodiment of the invention, if either the first or second reservation is subsequently cancelled, the remaining reservation can at some point be allocated so as to allow acceptance of the third reservation. For example, if, sometime between the acceptance of the second reservation and the request for the third reservation, the first reservation was cancelled, then the third reservation could be accepted. That is, because the category space reservations would include a small ballroom for the second reservation and a large ballroom for the third reservation, both of could be accommodated (e.g., DHI and ABCEFG, or AE and BCDFGHI).

However, it is often the case that a reservation management system does not have the liberty to establish a reservation based upon category space. This is because customers may request specific space for any number of reasons (e.g., requesting the ballroom with the ocean view). This becomes an additional source for generating revenue, as customers are typically willing to pay more for such specific requests. The function space reservation management system in one embodiment maintains the flexibility to allocate specific space when requested and category space otherwise.

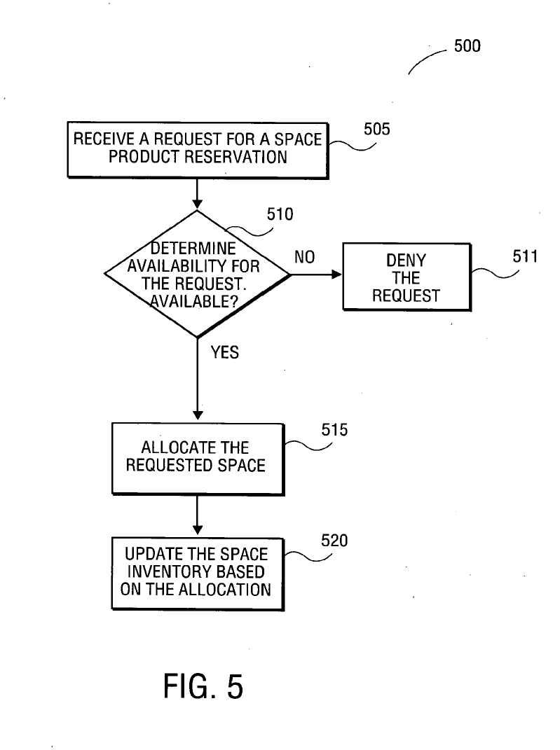

FIG. 5 illustrates a process by which a space product is allocated to fulfill the requirements of a reservation request in accordance with one embodiment of the invention. Process 500, shown in FIG. 5, begins with operation 505 in which a reservation request for a space product is received. The request may be for specific space or category space as discussed above.

At operation 510 the reservation request is evaluated to determine the availability of the space requested. If the space requested is unavailable, the reservation request is denied at operation 511.

If, at operation 510, the space requested is available, the reservation management system allocates the space to fulfill the requirements of the reservation request at operation 515. At operation 520 the reservation management system updates the space product inventory based upon the allocation of space.

In determining availability, the reservation management system concurrently evaluates category space and specific space inventory. For one embodiment, this is effected through use of a common reservation table.

An embodiment of the invention allows all category space reservations to be quickly mapped to specific space at any particular time to present an optimal specific space allocation for presentation to a user (e.g., a hotel sales manager) based on current valid reservations. This allows a user to verify availability for pending reservations. Also, as the particular time of the reservations draws near, the category space allocations will have to be mapped to specific space allocations so the function spaces can be appropriately configured and so each customer will know where to go. That is, as the function date approaches event staff will have to know which function rooms are assigned to which functions. Category reservations will eventually have to be assigned to specific space. These assignments are made that are best suited to optimize space utilization.

Various embodiments of the invention allow quick and accurate determinations of function space availability and pricing based upon numerous and complex, extant pricing rules. Moreover, embodiments of the invention allow the implementation of more complex availability and pricing rules. For example, for one embodiment, an available function space may have a threshold revenue associated with it that determines the minimum amount of revenue to warrant the use of the space. For example, the price at which a ballroom for a particular event is rented may be determined by consideration of many factors, including the profit on supplementary sales, such as food and beverages served at the event, and the number of guest rooms rented in conjunction with the event. For example, the threshold profit for a ballroom on a Saturday evening may by $5,000. If it is determined that the profit on the food and beverages served at the event is $2,000, and the profit for guest room rentals associated with the event is $1,000, then the rental price for the function space may be determined to be $2,000.

Additionally, for alternative embodiments, the available function space is divided into day-parts for a particular day, with each day-part having an associated threshold value as described above. For example, it may be determined that, for a given function space, it is practical to divide a typical day into, for example, 3 indivisible day-parts, based on typical use, and assign a threshold profit to each. For example, market conditions may indicate that a conference room be divided into a morning day-part (8:00-12:00), an afternoon day-part (12:00-4:00) and an evening day-part (4:00-11:00), with threshold profits of $500, $500 and $800, respectively. In such a situation, an accurate price quote for a reservation request for a luncheon from 11:00-2:30 may be $1,000 since such a reservation includes two indivisible day-parts at $500 each. On the other hand, an accurate price quote for a reservation request for an afternoon meeting from 4:30-6:00 and a party from 8:00-10:00 may be only $800 for both events since they fall within an indivisible day-part.

These simple examples indicate how complex pricing calculations can become when taking into account all of the considerations that affect marketability and revenue. The function space reservation management system of one embodiment makes it practical to employ pricing algorithms of vast complexity.

### General Matters

Embodiments of the invention may be applied to provide a function space reservation system that allows sophisticated and complex availability and pricing algorithms to be employed to provide real-time availability determinations and price quotes.

Any number of algorithms may be applied that consider varying sets of factors, or assign greater or lesser weight to each of the factors. For example, at a particular property, day-of-the-week may be a heavily weighted factor for reservations for function space on Friday or Saturday evenings. Another property may not even consider time-of-year or factor it differently. For example, at a property in a country where Christmas is celebrated (e.g., the U.S.), function space for a Saturday evening in mid-December may be priced at a premium, whereas comparable function space for the same day at a property in a different country (e.g., Iraq) may be priced at a discount.

For one embodiment, the function space reservation management system employs a rules-based pricing engine that provides a logical abstraction of pricing rules as described in copending U.S. application Ser. No. 10/414,596, filed on Apr. 15, 2003, entitled “A METHOD FOR IMPLEMENTING A RULES-BASED ENGINE,” and assigned to the same assignee as the present application.

For one embodiment, authorization levels and overbooking are employed to provide optimal use of space products. That is, given that the demand for space fluctuates often, the hotels need to have away of adjusting to the demand. Using authorization levels, the hotels can accept more reservations than the number of physical spaces available. Then if certain reservations are cancelled, the hotel still has enough reservations to fully use the particular space. For example, if a hotel has 5 small rooms, it might create a “small” category, and set the authorization level for a specific period of time to 7. This would allow the hotel to accept 2 extra reservations. An overbooking is a reservation that has been accepted even though it exceeds the authorization level for the function space. For one embodiment, an option, (a waiting queue beyond overbookings) is used. When a function is cancelled the reserved space is reassigned to functions that were overbooked and optioned. That is, the established reservation is released and the space is reallocated.

For one embodiment, functions may be reserved over a large configured space and long time period and later detailed into many sub-functions each using a portion of the space and time. For example, suppose a large organization wishes to hold a conference at some tentative time in the distant future (e.g., one year later). At the time of making the reservation the customer does not have information regarding the number and details of sub-functions. A sub function can have any function space that is wholly contained within the parent function space and may have any start and end times within the time constraints of the parent function reservation.

Initially the overall function space is determined and the largest contiguous space necessary for the function is reserved as a category booking to be used as a placeholder. Then over a period of time, as the sub-function details become available, more specific reservations are established eventually culminating in specific assignments as described above.

### Graphical Representation of Space Bookings

Prior art schemes typically employ a Gantt chart for displaying a schedule graphically. It consists of a horizontal bar chart with a time as the horizontal axis and booked space as the vertical axis. For one embodiment of the invention, space bookings are displayed as bars ranging from the start time to the end time for a particular date and particular space. The display may include indicators to display various information used to determine the reserved time (e.g., setup and teardown times). For one embodiment an overbooking is represented by two bars overlapping along the same vertical axis. For embodiment a space product diary is implemented to provide graphical display of four types of related bookings.

Regular inventory bookings are bookings that indicate that a room is occupied for a given period of time. It does not mean that another booking may be placed here, however the new booking would be an overbooking for the room.

Dependency inventory bookings are bookings that indicate that for a given period of time, a space that shares the current space as a component is already holding a booking. For example, for three spaces AB, A and B, if A and B are components of the room AB, then a booking on AB during a specific period in time, results in no bookings to be allowed in A or B for the same period of time. This does not preclude an overbooking, but the occupancy of the space is displayed.

Temporarily assigned bookings are created by the system to display an optimal location for a category booking. This is not an actual booking but merely a suggestion as to where a category booking may be assigned (i.e., when assigned into a specific space booking).

Over-authorization bookings are created when a category booking cannot be assigned at the specific space level because the physical space that the category contains has already been booked. For example, for a large category that contains rooms ABC and DEF, even though the large category only has two components, a third or subsequent booking may be made depending on the authorization level set for the category. Such booking would remain at the category level.

For one embodiment the graphical representation will display a hierarchical relationship between categories and their specific space components. Tying the different types of bookings with the vertical axis, allows the user to see the availability over a given time period for particular spaces as empty slots in graphical display.

Importantly, while several embodiments of the invention have been described in the context of providing availability and pricing information within the hospitality industry, embodiments of the invention may be likewise applicable to other industries that sell function space employing complex pricing rules. For example, embodiments are also applicable to some aspects of the travel industry and to availability and pricing determinations for function space at arenas, auditoriums and amphitheaters.

Embodiments of the invention include various operations. Many of the methods are described in their most basic form, but operations can be added to or deleted from any of the methods without departing from the basic scope of the invention.

It will be apparent to those skilled in the art that the operations of the invention may be performed by hardware components or may be embodied in machine-executable instructions, which may be used to cause a general-purpose or special-purpose processor or logic circuits programmed with the instructions to perform the operations. Alternatively, the steps may be performed by a combination of hardware and software. The invention may be provided as a computer program product that may include a machine-readable medium having stored thereon instructions, which may be used to program a computer (or other electronic devices) to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A computer-implemented method performed in a data processing system for establishing a space reservation, the method comprising:
receiving at the data processing system a request for the space reservation, the request comprising a plurality of criteria; and
establishing the space reservation based upon a function space category of a plurality of function space categories, wherein each function space category of the plurality of function space categories corresponds to a space configuration of a plurality of space configurations, the plurality of space configurations having a first set of space configurations and a second set of space configurations, wherein each space configuration in the first set of space configurations is formed from an indivisible space of a plurality of indivisible spaces and each space configuration in the second set of space configurations is formed from a combination of two or more adjacent indivisible spaces of the plurality of indivisible spaces, and
wherein the data processing system comprises a processor to perform the establishing step and a memory to store the plurality of function space categories and correspondence information between the plurality of function space categories and the plurality of space configurations.

2. The computer-implemented method of claim 1 wherein a subset of one space configuration of the plurality of space configurations is the same as a subset of a second space configuration of the plurality of space configurations.

3. The computer-implemented method of claim 1 wherein the plurality of indivisible spaces comprises of indivisible spaces of various sizes.

4. The computer-implemented method of claim 1 wherein the establishing the space reservation comprises determining from an availability information, availability in the function space category for the space reservation request.

5. The computer-implemented method of claim 1 further comprising:
mapping the function space category reservation to a corresponding space configuration of the plurality of space configurations, wherein the mapping is delayed to a later date but earlier than a date on which the space is required.

6. The computer-implemented method of claim 1 further comprising:
receiving at the data processing system a second request for a second space reservation,
the request comprising a plurality of second criteria;
establishing a second space reservation based upon a second function space category of the plurality of function space categories; and
mapping each of the function space category reservation and the second function space category reservation to a corresponding space configuration of the plurality of space configurations, wherein the mapping step is performed at a later date which is after establishing each of the space reservation and the second space reservation but is earlier than the date on which each of the space reservation and the second space reservation is required, and
wherein the delayed mapping enables optimal allocation of an indivisible space or a combination of two or more adjacent indivisible spaces of their corresponding space configurations.

7. The computer-implemented method of claim 1 further comprising generating a price quote based upon a plurality of pricing rules.

8. The computer-implemented method of claim 1 wherein the plurality of criteria comprises one or more of: a required date and time for the requested space, geographical location, quality-specific criteria, or setup style and time.

9. The computer-implemented method of claim 1 wherein the memory in the data processing system stores availability and pricing information for the plurality of function space categories for an individual property or for a plurality of individual properties at different geographical locations.

10. A machine-readable storage medium storing a plurality of instructions executable by a processor, the plurality of instructions enabling a data processing system to establish a space reservation, the plurality of instructions comprising instructions to:
receive at the data processing system a request for the space reservation, the request comprising a plurality of criteria; and
establish the space reservation based upon a function space category of a plurality of function space categories, wherein each function space category of the plurality of function space categories corresponds to a space configuration of a plurality of space configurations, the plurality of space configurations having a first set of space configurations and a second set of space configurations, wherein each space configuration in the first set of space configurations is formed from an indivisible space of a plurality of indivisible spaces and each space configuration in the second set of space configurations is formed from a combination of two or more adjacent indivisible spaces of the plurality of indivisible spaces, and
wherein the data processing system comprises a processor to perform the establishing step and a memory to store the plurality of function space categories and correspondence information between the plurality of function space categories and the plurality of space configurations.

11. The machine-readable storage medium of claim 10 wherein a subset of one space configuration of the plurality of space configurations is the same as a subset of a second space configuration of the plurality of space configurations.

12. The machine-readable storage medium of claim 10 wherein the plurality of indivisible spaces comprises of indivisible spaces of various sizes.

13. The machine-readable storage medium of claim 10 wherein the establishing the space reservation comprises determining from availability information, availability in the function space category for the space reservation request.

14. The machine-readable storage medium of claim 10 further comprising:
mapping the function space category reservation to a corresponding space configuration of the plurality of space configurations, wherein the mapping is delayed to a later date but earlier than a date on which the space is required.

15. The machine-readable storage medium of claim 10 further comprising:
receiving at the data processing system a second request for a second space reservation, the request comprising a plurality of second criteria;
establishing a second space reservation based upon a second function space category of the plurality of function space categories; and
mapping each of the function space category reservation and the second function space category reservation to a corresponding space configuration of the plurality of space configurations, wherein the mapping step is performed at a later date which is after establishing each of the space reservation and the second space reservation but is earlier than the date on which each of the space reservation and the second space reservation is required, and wherein the delayed mapping enables optimal allocation of an indivisible space or a combination of two or more adjacent indivisible spaces of their corresponding space configurations.

16. A data processing system for establishing a space reservation, the data processing system comprising:
a processor; and
a memory for storing instructions executable by the processor and for storing information on a plurality of function space categories and correspondence information between the plurality of function space categories and a plurality of space configurations, wherein the processor is capable of:
receiving at the data processing system a request for the space reservation, the request comprising a plurality of criteria; and
establishing the space reservation based upon a function space category of the plurality of function space categories, wherein each function space category of the plurality of function space categories corresponds to a space configuration of the plurality of space configurations, the plurality of space configurations having a first set of space configurations and a second set of space configurations,
wherein each space configuration in the first set of space configurations is formed from an indivisible space of a plurality of indivisible spaces and each space configuration in the second set of space configurations is formed from a combination of two or more adjacent indivisible spaces of the plurality of indivisible spaces, and
wherein the data processing system comprises a processor to perform the establishing step and a memory to store the plurality of function space categories and correspondence information between the plurality of function space categories and the plurality of space configurations.

17. The data processing system of claim 16 wherein a subset of one space configuration of the plurality of space configurations is the same as a subset of a second space configuration of the plurality of space configurations.

18. The data processing system of claim 17 wherein the establishing the space reservation comprises determining from availability information, availability in the function space category for the space reservation request.

19. The data processing system of claim 10 further comprising:
mapping the function space category reservation to a corresponding space configuration of the plurality of space configurations, wherein the mapping is delayed to a later date but earlier than a date on which the space is required.

20. The data processing system of claim 10 further comprising:
receiving at the data processing system a second request for a second space reservation,
the request comprising a plurality of second criteria;
establishing a second space reservation based upon a second function space category of the plurality of function space categories; and
mapping each of the function space category reservation and the second function space category reservation to a corresponding space configuration of the plurality of space configurations, wherein the mapping step is performed at a later date which is after establishing each of the space reservation and the second space reservation but is earlier than the date on which each of the space reservation and the second space reservation is required, and wherein the delayed mapping enables optimal allocation of an indivisible space or a combination of two or more adjacent indivisible spaces of their corresponding space configurations.
